(19) United States
(12) Patent Application Publication
(10) Pub. No.: US 2025/0139485 A1
(43) Pub. Date: May 1, 2025

(54) SYSTEMS AND METHODS OF ZZ CANCELLATION USING A DRIVEN RESONATOR IN A SUPERCONDUCTING QUANTUM PROCESSOR UNIT

(71) Applicant: FERMI RESEARCH ALLIANCE, LLC, Batavia, IL (US)

(72) Inventors: Ziwen Huang, Batavia, IL (US); Taeyoon Kim, Batavia, IL (US); Tanay Roy, Batavia, IL (US); Yao Lu, Batavia, IL (US); Shaojiang Zhu, Batavia, IL (US)

(21) Appl. No.: 18/933,618

(22) Filed: Oct. 31, 2024

Related U.S. Application Data
(60) Provisional application No. 63/546,745, filed on Oct. 31, 2023.

(51) Int. Cl. G06N 10/40

(52) U.S. Cl. CPC G06N 10/40

(57) ABSTRACT

A superconducting quantum processor unit (QPU) comprising a resonator having a resonator frequency ω_{C} coupled between a control qubit having a control frequency ω_{L} and a target qubit having a target frequency ω_{R}. The control frequency ω_{L} is detuned from the target frequency ω_{R} at less than a detuning gap of the resonator frequency ω_{C}. A microwave drive applies to the resonator a resonator drive frequency ω_{c}^{d} at a drive strength [symbol] substantially equal to a ZZ-free operating point [symbol] ₀ of a controlled phase for the control qubit, resonator, and target qubit to induce entanglement between the control and target qubits. The effective ZZ coupling between the control and target qubits vanishes at operating point [symbol] ₀. The resonator may be of either a 2D or a 3D high-coherence resonator type. Control and target qubits may be of a fixed-frequency transmon type (e.g., cross-resonance (CR) Controlled-NOT (CNOT) or adiabatic Controlled-Z (CZ)).

### CROSS-REFERENCE TO RELATED APPLICATIONS

This application is related to and claims the benefit under 35 U.S.C. § 119 (e) of U.S. Provisional Patent Application Ser. No. 63/546,745 filed by the inventors of the present application on Oct. 31, 2023 and titled SYSTEMS AND METHODS OF ZZ CANCELLATION USING A DRIVEN RESONATOR IN A SUPERCONDUCTING QUANTUM PROCESSOR UNIT, the entire contents of which are incorporated herein by reference.

### STATEMENT REGARDING FEDERALLY SPONSORED RESEARCH OR DEVELOPMENT

The invention described in this patent application was made with Government support under the Fermi Research Alliance, LLC, Contract Number DE-AC02-07CH11359 awarded by the U.S. Department of Energy. The Government has certain rights in the invention.

### FIELD OF THE INVENTION

The present invention relates generally to the field of quantum computing and, more particularly, to systems and methods for error mitigation in superconducting quantum platforms.

### BACKGROUND OF THE INVENTION

Engineering high fidelity two-qubit gates is an indispensable step toward practical quantum computing. A typical requirement for faster entangling operations between multiple qubits is strong interactions. However, increasing coupling strength may result in larger stray interactions (notably, stronger ZZ couplings), which limit the fidelities of both single and two-qubit gates. For superconducting quantum platforms, such stray interaction between qubits may cause significant coherent errors.

Known approaches to mitigating coherent errors in superconducting qubits include fine tuning hardware parameters or introducing usually noisy flux-tunable couplers. In the latter approach, couplers may mitigate unwanted crosstalk and can result in increased gate fidelities. However, for transmon processors, which are widely used, such tunable elements also lead to extra decoherence errors due to the high loss rates of such couplers. Alternative strategies for ZZ cancellation include using multi-path couplers and AC Stark shifts. By either fine tuning the parameters of the bus coupler or Stark driving the transmon qubits, the ZZ interaction may be suppressed without any flux tunability.

Accordingly, a need exists for a solution to at least one of the aforementioned challenges in cancelling stray interaction between qubits so as to mitigate coherent errors. More specifically, a need exists for quantum computing devices, systems, and operating methodologies that facilitate ZZ cancellation without extra noisy components, such that coherence times of employed qubits are preserved. These are all features and capabilities of the present invention as disclosed and claimed, which provides solutions to the multiple shortcomings of prior art inventions in this field.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a quantum computing system that employs a high-coherence microwave resonator to cancel unwanted ZZ coupling via resonator-induced-phase (RIP) interaction. In one embodiment of the present invention, a superconducting quantum processor unit (QPU) may comprise a resonator device coupled between a control qubit device and target qubit device. The control qubit device may be characterized by a control frequency ω_{L}, and the target qubit device may be characterized by a target frequency ω_{R}. The resonator device may be characterized by a resonator frequency ω_{C} which may be detuned from both the control frequency ω_{L} and the target frequency ω_{R} (e.g., a detuning gap of approximately 5 gigahertz (GHz)). Relatedly, the control frequency ω_{L} may be detuned from the target frequency ω_{R} at less than the detuning gap of the resonator frequency ω_{C}.

A microwave drive may be used to apply to the resonator device a resonator drive frequency ω_{c}^{d} that may induce entanglement between the control qubit device and the target qubit device. More specifically, the resonator drive frequency ω_{c}^{d} may be applied at a drive strength [symbol] substantially equal to a ZZ-free operating point [symbol] ₀ of a controlled phase for the control qubit, resonator, and target qubit devices. The effective ZZ coupling between the control and target qubits may vanish at the ZZ-free operating point [symbol] ₀. The resonator device may be in a displaced vacuum state during the controlled phase.

In certain embodiments, the resonator device may be of either a two-dimensional (2D) high-coherence resonator type or a three-dimensional (3D) high-coherence resonator type. Also for example, the resonator device may comprise a superconducting radio frequency (SRF) cavity. Each of the control and target qubit devices may be of a two-qubit electrode type and may be capacitively connected to the resonator device. Each of the control and target qubit devices may be of a fixed-frequency transmon type. For example, the superconducting quantum processor unit (QPU) may be of a two-qubit entangling gate type (e.g., a cross-resonance (CR) Controlled-NOT (CNOT) gate type; or an adiabatic Controlled-Z (CZ) gate type).

In an alternative embodiment of the present invention, a qubit-resonator chain may comprise N qubit devices, including a j^{th} qubit device characterized by a control frequency ω_{q,j} and a j+l^{th} qubit device characterized by a control frequency ω_{q,j}+1. N-1 resonator devices may be coupled between adjacent pairs of the N qubit devices, including a j^{th} resonator device characterized by a resonator frequency ω_{c,j} having a detuning gapⱼ from the control frequency ω_{q,j} and from the control frequency ω_{q,j+1}. A microwave drive may be configured to apply to the j^{th} resonator device a j^{th} resonator drive frequency ω_{c,j}^{d} at a drive strength [symbol] ⱼ substantially equal to a ZZ-free operating point [symbol] _{0,j} of a controlled phase for the j^{th} qubit, j^{th} resonator, and j+l^{th} qubit devices. In certain embodiments, an Nth resonator device may be coupled between a non-adjacent pair of the N qubit devices.

In a method aspect of the present invention, a superconducting quantum processor unit (QPU) comprising a control qubit device characterized by a control frequency ω_{L}, a target qubit device characterized by a target frequency ω_{R}, and a resonator device coupled between the control and target qubit devices and characterized by a resonator frequency ω_{C} having a detuning gap from the control frequency ω_{L} and from the target frequency ω_{R}; may be operated by using a microwave drive to apply a resonator drive frequency ω_{c}^{d} to the resonator device at a drive strength [symbol] substantially equal to a ZZ-free operating point [symbol] ₀ of a controlled phase for the control qubit, resonator, and target qubit devices. Optional method steps may include applying a control drive frequency ω_{L}^{d} to the control qubit device and/or applying a target drive frequency ω_{R}^{d} to the target qubit device.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a schematic diagram of a composite transmon-resonator-transmon lumped-element model of a first exemplary ZZ cancellation system according to an embodiment of the present invention;

FIG. 2A is a graph of time evolution of two-qubit controlled phase as a function of driving strength for a ZZ cancellation method according to an embodiment of the present invention;

FIG. 2B is a graph of energy shift of transition frequency as a function of the driving strength of the ZZ cancellation method of FIG. 2A;

FIG. 3 is a schematic diagram of cross-resonance (CR) gates error channels annotated with two-qubit detuning, driving strength, and two-qubit effective coupling strength and with ZZ error removed according to an embodiment of the present invention;

FIG. 4A is a graph of respective drives on control and target cubits of a 0-CNOT gate type for a ZZ cancellation system according to an embodiment of the present invention;

FIG. 4B is a graph of respective drives on control and target cubits of a 1-CNOT gate type for a ZZ cancellation system according to an embodiment of the present invention;

FIGS. 5A and 6A are graphs of exemplary evolution of computational states during 40-ns gates of a 0-CNOT gate type for a ZZ cancellation system according to an embodiment of the present invention;

FIGS. 5B and 6B are graphs of exemplary evolution of computational states during 40-ns gates of a 1-CNOT gate type for a ZZ cancellation system according to an embodiment of the present invention;

FIG. 7A is a graph of minimized coherent gate error versus given gate times for entangling gates of a 0-CNOT gate type for a ZZ cancellation system according to an embodiment of the present invention;

FIG. 7B is a graph of minimized coherent gate error versus given gate times for entangling gates of a 1-CNOT gate type for a ZZ cancellation system according to an embodiment of the present invention;

FIG. 8 is a graph of envelopes of resonator drives enabling phase entangling of an adiabatic CZ gate type for a ZZ cancellation system according to an embodiment of the present invention;

FIG. 9 is a graph of optimized gate durations and corresponding resonator diabatic errors as a function of n of the ZZ cancellation method of FIG. 8;

FIG. 10 is a schematic diagram of a multitransmon chain connected by resonators of a second exemplary ZZ cancellation system according to an embodiment of the present invention; and

FIG. 11 is a schematic diagram of a transmon lattice connected by resonators of a third exemplary ZZ cancellation system according to an embodiment of the present invention.

Like reference numerals refer to like parts throughout the several views of the drawings.

### DETAILED DESCRIPTION OF THE INVENTION

The present invention will now be described more fully hereinafter with reference to the accompanying attachments, in which preferred and alternative embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those of ordinary skill in the art.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

As used herein, the word “exemplary” or “illustrative” or “shown” means “serving as an example, instance, or illustration.” Any implementation described herein as “exemplary” or “illustrative” is not necessarily to be construed as preferred or advantageous over other implementations. All of the implementations described below are exemplary implementations provided to enable persons of ordinary skill in the art to make or use the embodiments of the disclosure without undue experimentation or a degree of experimentation beyond that which is customary in the art, and are not intended to limit the scope of the disclosure, which is defined by the claims.

Systems and associated methods for ZZ cancellation using a drive resonator in a superconducting quantum processing unit according to embodiments of the present invention are now described in detail. Throughout this disclosure, the present invention may be referred to as a ZZ cancellation system or method; a fast ZZ-free entangling gates system or method; a ZZ-free quantum computing system or method; a resonator-induced-phase (RIP) ZZ cancellation system or method; a quantum computing system; a superconducting quantum processor unit (QPU); a system; and/or a method. Those skilled in the art will appreciate that this terminology is only illustrative and does not affect the scope of the invention. For instance, the present invention may just as easily relate to any resonator-induced-phase (RIP) assisted methodology for which the amplitude and/or frequency of a drive serve as control knobs.

In general, certain embodiments of the present invention may include a non-tunable architecture that may be free of both the fine-tuning of hardware parameters and/or the direct drives on qubits commonly employed in known ZZ cancellation schemes. Such an alternative architecture may use a high-coherence microwave resonator to cancel unwanted ZZ coupling via the resonator-induced-phase (RIP) interaction. For such cancellation, a constant off-resonant drive that displaces the resonator state (approximately ten photons in the steady state) may be applied. Because of the dispersive shifts, the displacement of the resonator state may depend on the states of the two transmon qubits, which in turn may introduce a dynamical ZZ interaction between the qubits. The strength of this coupling advantageously may be highly tunable and may be employed to cancel the static ZZ coupling.

Embodiments of the present invention may represent advantageous improvements over known ZZ-cancellation schemes. For example, and without limitation, the present invention a) is a microwave-only approach that may not necessitate the use of the typically noisy flux-tunable couplers; b) is more robust to deviations from targeted hardware parameters, as the flexible microwave control may compensate for parameter variations; and c) employs only a drive acting on the coupling resonator for ZZ cancellation, which still may be compatible with protocols for single-qubit operations and measurement. By employing superconducting cavities with high coherence times, the resonator photon loss may only negligibly affect gate fidelities.

The proposed architecture of certain embodiments of the present invention may employ one or more of a family of fast entangling gates between qubits, including cross-resonance (CR) controlled-NOT (CNOT) gates (S 40 nanoseconds (ns)) and adiabatic controlled-Z (CZ) gates (≤140 ns). Particularly, the CR-CNOT gates may be significantly accelerated since the cancellation of the static ZZ coupling (approximately 6 Megahertz (MHz) as modelled hereinbelow) may allow stronger qubit coupling without introducing coherent errors caused by stray interactions. As further modelled hereinbelow, the infidelity of the CR gates may reach below 10⁻⁴ because of the shorter gate times. The stronger coupling also may allow a much larger qubit frequency separation compared to those on known CR architectures, which may alleviate the issue of frequency crowding among the transmon qubits.

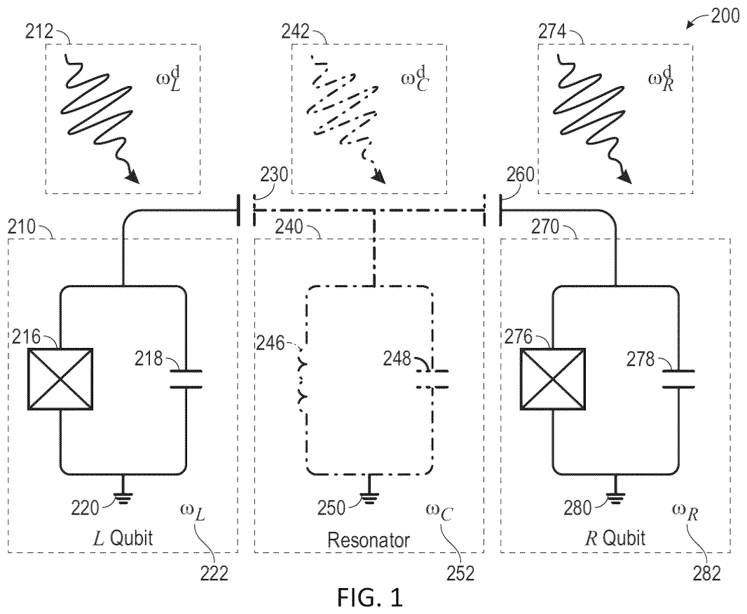

MODEL AND ZZ CANCELLATION: Referring initially to FIG. 1, a lumped-element model of a composite transmon-resonator-transmon system 200 will now be described in detail. Generally, various circuit designs according to certain embodiments of the present invention may comprise two superconducting qubits, both capacitively coupled to a central linear resonator. More specifically, a first transmon qubit 210 (also referred to hereinafter as a left qubit) and a second transmon qubit 270 (also referred to hereinafter as a right qubit) may be capacitively coupled to a high-coherence resonator 240, which may be modeled as a lumped-element resonator. The left (L) qubit 210, right (R) qubit 270, and resonator 240 each may include a respective capacitor 218, 278, 248, and a respective ground 220, 280, 250. The left (L) qubit 210, right (R) qubit 270, and resonator 240 each may receive a respective drive frequency 212, 274, 242 (the frequencies of the drives on the three elements jointly denoted by ω_{L,R,C}), and may experience a respective excitation energy 222, 282, 252 (the excitation energies of the first transmon qubit (L) 210, second transmon qubit (R) 270, and coupling resonator (C) 240 jointly denoted by ω_{L,R,C}).

The Hamiltonian of this system 200 may be as shown in Equation 1, as follows:

$$\hat{H} ( t ) = {\sum }_{v = L , R} {\hat{H}}_{v} + {\hat{H}}_{C} + {\hat{H}}_{int} + {\hat{H}}_{D} ( t ) \qquad ( 1 )$$

where Ĥ_{L} denotes the Hamiltonian of the left qubit, Ĥ_{R} denotes the Hamiltonian of the right qubit, Ĥ_{C} denotes the resonator Hamiltonian, and Ĥᵢₙₜ denotes their interaction. Besides the static terms, the time-dependent Hamiltonian Ĥ_{D(t)} describes the drives on the three components.

As modelled in system 200 of FIG. 1, the two qubits 210, 270 may be considered as fixed-frequency transmon qubits, which are among the most coherent superconducting quantum elements and have been demonstrated to possess coherence times approaching 1 millisecond (ms). The Hamiltonian of the left 210 (right 270) transmon qubit may be given by Ĥ_{L}(R)-4E_{C}_{_{L(R)}}\hat{n}_{L(R)}²−E_{J}_{_{L(R)}}COS\hat{φ}_{L(R)}, where ĤL(R) and \hat{φ}_{L(R)} denote the charge and phase operators, respectively, of the left 210 (right 270) qubit. The central lumped-element resonator 240 may be assumed to be physically implemented as a two-dimensional (2D) or three-dimensional (3D) high-coherence resonator. The Hamiltonian of this resonator may be given by Ĥ_{C}=w̅_{c}â†â, where â(â†) denotes the annihilation (creation) operator, and w̅_{C} is the bare resonator frequency. The interaction term may be specified by Ĥᵢₙₜ=(â+â†) (g_{L}\hat{n}_{L}+g_{R}\hat{R}\hat{n}_{R}), where g_{L,R} denotes the qubit-resonator coupling strength. For those three components 210, 270, 240, the drive term Ĥ_{D}(t) may be specified as the charge drives that address each element. In the bare basis, it may take on the form shown in Equation 2, as follows:

$$\hat{H} ( t ) = {\sum }_{v = L , R} {D}_{v} ( t ) {\hat{n}}_{v} + D ( t ) ( {\hat{a}}^{†} + \hat{a} ) \qquad ( 2 )$$

where D_{L,R}(t) and D(t) denote the time-dependent drive strengths.

Because of the coupling between the three components 210, 274, 240 described by Ĥᵢₙₜ, the true eigenstates of this composite system 200 are hybridizations of the bare eigenstates of the Hamiltonians H_{L(R)} and Ĥ_{C}. In terms of these true (dressed) eigenstates, the Hamiltonian in Equation 1 may be expressed as shown in Equation 3, as follows:

$${\hat{H}}^{′} ( t ) \approx {\sum }_{v = L , R} ( {ω}_{v} {\hat{b}}_{v}^{†} {\hat{b}}_{v} + \frac{{η}_{v}}{2} {\hat{b}}_{v}^{†} {\hat{b}}_{v}^{†} {\hat{b}}_{v} {\hat{b}}_{v} + {χ}_{v} {\hat{b}}_{v}^{†} {\hat{b}}_{v} {\hat{a}}^{†} \hat{a} ) + {χ}_{LR}^{′} {\hat{b}}_{L}^{†} {\hat{b}}_{L} {\hat{b}}_{R}^{†} {\hat{b}}_{R} + {ω}_{C} {\hat{a}}^{†} \hat{a} + \frac{{η}_{C}}{2} {\hat{a}}^{†} {\hat{a}}^{†} \hat{a} \hat{a} + {\hat{H}}_{D}^{′} ( t ) \qquad ( 3 )$$

where \hat{b}_{L(R)} is the annihilation operator for the left 210 (right 270) transmon qubit; and ω_{L,R,C} denote the dressed frequencies 222, 282, 252 of the left qubit 210, right qubit 270, and resonator 240, respectively. As is common in experiments on fixed-frequency transmons, the transmon frequences 222, 282 may be considered to be around 4.5 gigahertz (GHz); and the frequency 252 of the resonator 240 may be designed to be significantly detuned from those of the transmons ω_{L,R} 222, 282 to serve only as a passive coupler. As described herein, this detuning may be considered to be approximately 5 GHz. The anharmonicity of the left 210 (right 270) transmon qubit is denoted by η_{L,R}.

As modelled herein, because of the hybridization with the two nonlinear transmon qubits 210, 270, the resonator 240 also may require a small self-Kerr term in its Hamiltonian, whose strength is denoted by η_{c}. The full dispersive shift between the left 210 (right 270) qubit and the resonator 240 is denoted by X_{L,(R)}. Because of their mutual coupling to the resonator 240 and relatively closer frequencies 222, 282; the two qubits 210, 270 also share a ZZ interaction, whose magnitude is denoted by X_{L(R)}′. Finally, the Drive Hamiltonian H_{D}′(t) in Equation 3 may be transformed from Ĥ_{D}′(t) in Equation 1 after the dispersive shift (treatment).

ADIABATIC ELIMINATION AND ZZ CANCELLATION: According to Equation 3, the interaction between each qubit 210, 270 and the coupler resonator 240 may be described by the dispersive shift terms such as X_{L}b_{L}†â†â. If the passive resonator mode is kept in its ground state, these interactions may be safely neglected. However, upon applying a drive 242 on the resonator 240, the usually neglected interaction may induce entanglement between the two qubits 210, 270 (such interaction being an enabling element in the ZZ-free architecture of the present invention), as shown in Equation 4, as follows:

$${\hat{H}}_{D , C}^{′} ( t ) = 2 D cos ( {ω}_{C}^{d} t ) ( {\hat{a}}^{†} + \hat{a} ) \qquad ( 4 )$$

To see the ZZ cancellation, an effective Hamiltonian may be derived with the resonator degree of freedom eliminated. After a frame transformation according to the unitary Û_{c}(t)=exp(−iω_{C}^{d}tâ†â), the Hamiltonian in the rotating frame (with fast-rotating terms neglected) may be given by Equation 5, as follows:

$$\begin{matrix}\tilde{H} = {\hat{U}}_{C}^{†} ( t ) \hat{H} ( t ) {\hat{U}}_{C} ( t ) - i {\hat{U}}_{C}^{†} ( t ) {\hat{U}}_{C} ( t ) \\ \approx {\hat{H}}_{q}^{′} - {Δ}_{d} {\hat{a}}^{†} \hat{a} + \frac{{η}_{C}}{2} {\hat{a}}^{†} {\hat{a}}^{†} \hat{a} \hat{a} + D ( {\hat{a}}^{†} + \hat{a} ) + \\ {χ}_{L} {\hat{b}}_{L}^{†} {\hat{b}}_{L} {\hat{a}}^{†} \hat{a} + {χ}_{R} {\hat{b}}_{R}^{†} {\hat{b}}_{R} {\hat{a}}^{†} \hat{a}\end{matrix} \qquad ( 5 )$$

where Δ_{d}=ω_{C}^{d}−ω_{C}, and H_{q}′ is the Hamiltonian for two transmons. Note that, because the self-Kerr strength η_{c} is much smaller than the other coefficients in the present parameter regime, the self-Kerr term is neglected in the following analytical derivation for simplicity.

The drive term D(â†+â) may displace the resonator state away from the zero-photon state. Therefore, the resonator 240 may no longer be assumed to only stay in its ground state. However, one may perform a transformation to adiabatically eliminate the drive term and further the resonator degree of freedom. The unitary useful for such elimination is given by Equation 6, which further transforms Equation 5 into Equation 7 as follows:

$${\hat{U}}_{dis} = exp [ \frac{D ( {\hat{a}}^{†} - \hat{a} )}{{Δ}_{d} - {χ}_{L} {\hat{b}}_{L}^{†} {\hat{b}}_{L} - {χ}_{R} {\hat{b}}_{R}^{†} {\hat{b}}_{R}} ] \qquad ( 6 )$$

$$\begin{matrix}{\tilde{H}}_{dis} = {\hat{U}}_{dis}^{†} \tilde{H} {\hat{U}}_{dis} \\ \approx {\hat{H}}_{q}^{′} + ( - {Δ}_{d} + {χ}_{L} {\hat{b}}_{L}^{†} {\hat{b}}_{L} + {χ}_{R} {\hat{b}}_{R}^{†} {\hat{b}}_{R} ) {\hat{a}}^{†} \hat{a} + \\ \frac{{D}^{2}}{{Δ}_{d} - {χ}_{L} {\hat{b}}_{L}^{†} {\hat{b}}_{L} - {χ}_{R} {\hat{b}}_{R}^{†} {\hat{b}}_{R}}\end{matrix} \qquad ( 7 )$$

Derivation of Equation 7 above may comprise the following steps:

First, because \hat{b}_{L(R)}†\hat{b}_{L(R)} commutes with D(â†−â)/(Δ_{d}−X_{L}\hat{b}_{L}†\hat{b}_{L}−X_{R}\hat{b}_{R}†\hat{b}_{R}), one may find that Û_{dis}†b_{L(R)}†\hat{b}_{L}(R)Û_{dis}=\hat{b}_{L(R)}†\hat{b}_{L(R)}. Therefore, H_{q}′ is unaffected under the transformation by Û_{dis}.

Meanwhile, the transformations of operators â, â† and â†â from Equation 5 are nontrivial (as noted hereinabove, the small resonator self-Kerr term η_{C}â†â†ââ/2 is neglected). Inserting the following Equations 8 and 9 into Û_{dis}†Û_{dis} may resolve to the displaced Hamiltonian of Equation 7:

$${\hat{U}}_{dis}^{†} \hat{a} {\hat{U}}_{dis} = \hat{a} + \frac{D}{{Δ}_{d} - {χ}_{L} {\hat{b}}_{L}^{†} {\hat{b}}_{L} - {χ}_{R} {\hat{b}}_{R}^{†} {\hat{b}}_{R}} \qquad ( 8 )$$

$${\hat{U}}_{dis}^{†} {\hat{a}}^{†} \hat{a} {\hat{U}}_{dis} = {\hat{a}}^{†} \hat{a} + \frac{D ( {\hat{a}}^{†} + \hat{a} )}{{Δ}_{d} - {χ}_{L} {\hat{b}}_{L}^{†} {\hat{b}}_{L} - {χ}_{R} {\hat{b}}_{R}^{†} {\hat{b}}_{R}} + {( \frac{D}{{Δ}_{d} - {χ}_{L} {\hat{b}}_{L}^{†} {\hat{b}}_{L} - {χ}_{R} {\hat{b}}_{R}^{†} {\hat{b}}_{R}} )}^{2} \qquad ( 9 )$$

The second line in Equation 7 contains both the transmon Hamiltonians and the remaining coupling between the transmon qubit and the resonator in this displaced frame. The latter interaction may lead to shifts of the qubit frequencies if the resonator is not in the displaced vacuum state. However, if the resonator initially has zero photons and the ramp-up of the drive strength is sufficiently slow, during this ramp-up, the state of the resonator may remain in the vacuum defined in the displaced frame. Given that the resonator has a sufficiently small decoherence rate, one may safely assume that the resonator remains in this vacuum during gate operations.

The third line in Equation 7 describes the RIP interaction between the two qubits 210, 270 introduced by the driven resonator 240. Approximately, in the limit of |X_{L}|, |X_{R}|<<|Δ_{d}|, the dynamical ZZ coupling appears as 2D² X_{L}X_{R}\hat{b}_{L}†b_{L}\hat{b}_{R}†\hat{b}_{R}/Δ_{d}³ after expanding the last line of Equation 7.

The dynamical ZZ coupling, in the limit of |X_{L}|, |X_{R}|<<|Δ_{d}|, may be obtained by expanding Equation 10, as follows:

$$\frac{{D}^{2}}{{Δ}_{d} - {χ}_{L} {\hat{b}}_{L}^{†} {\hat{b}}_{L} - {χ}_{R} {\hat{b}}_{R}^{†} {\hat{b}}_{R}} \approx \frac{{D}^{2}}{{Δ}_{d}} + \frac{{D}^{2}}{{Δ}_{d}^{2}} ( {χ}_{L} {\hat{b}}_{L}^{†} {\hat{b}}_{L} + {χ}_{R} {\hat{b}}_{R}^{†} {\hat{b}}_{R} ) + \frac{{D}^{2}}{{Δ}_{d}^{3}} {( {χ}_{L} {\hat{b}}_{L}^{†} {\hat{b}}_{L} + {χ}_{R} {\hat{b}}_{R}^{†} {\hat{b}}_{R} )}^{2} \qquad ( 10 )$$

which may result in the two-qubit coupling term 2D² X_{L}\hat{b}_{L}†b_{L}\hat{b}_{R}†\hat{b}_{R}/Δ_{d}³ described hereinabove.

This evaluation gives the approximate ZZ-free condition shown in Equation 11, as follows:

$$2 {χ}_{L} {χ}_{R} {D}^{2} / {Δ}_{d}^{3} = + {χ}_{LR}^{′} = 0 \qquad ( 11 )$$

However, this approximation only holds in the limit of |X_{L,R}|<<|Δ_{d}|. Beyond this limit, using the last line of Equation 7 to calculate the entangling strength may be more accurate. Specifically, the ZZ cancellation requires Equation 12, as follows:

$$Δ {E}_{zp} ( 1 , 1 ) + Δ {E}_{zp} ( 0 , 0 ) - Δ {E}_{zp} ( 1 , 0 ) - Δ {E}_{zp} ( 0 , 1 ) + {χ}_{LR}^{′} = 0 \qquad ( 12 )$$

where, as further shown in Equation 13, the following is defined:

$$Δ {E}_{zp} ( {j}_{L} , {j}_{R} ) = \frac{{D}^{2}}{{Δ}_{d} - {j}_{L} {χ}_{L} - {j}_{R} {χ}_{R}} \qquad ( 13 )$$

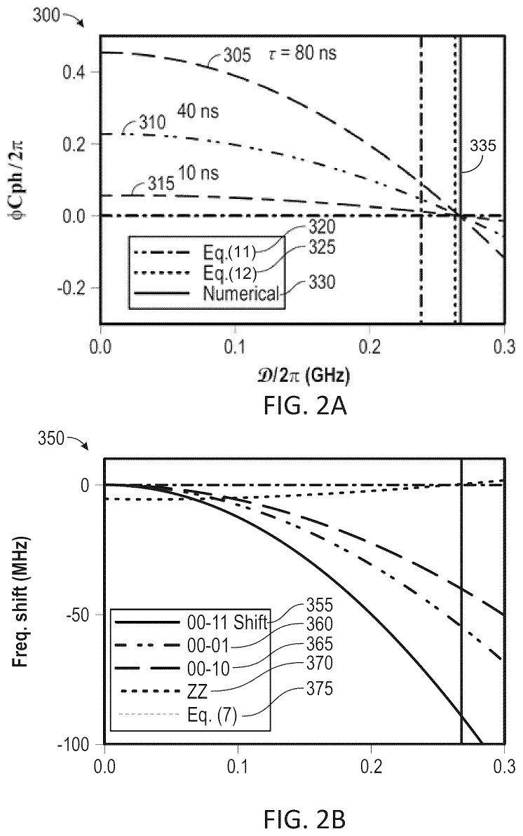

Referring now to FIGS. 2A and 2B, and continuing to refer to FIG. 1, to numerically confirm such a prediction one may perform a simulation 300 of the controlled phase in a transmon-resonator-transmon system described by the Hamiltonian of Equation 3, where the previously neglected resonator self-Kerr term is included. The controlled phase may be obtained by evaluating ϕ_{Cph}=ϕ₁₀+ϕ₀₁−ϕ₀₀ϕ₁₁ for a given evolution time τ and resonator driving strength [symbol] , where ϕⱼ_{_{L}}_{,j}_{_{R}} denotes the system's accumulated phase if the number of photons in the left 210 (right 270) transmon qubit is maintained at j_{L}(j_{R}). By varying [symbol] and t, the evaluated ϕ_{Cph} may vanish at all times for a certain [symbol] , implying the desired ZZ cancellation. Such a value considerably differs from the leading-order approximation 320 of Equation 11, but may be closely predicted by solving Equation 12 for [symbol] . The remaining deviation between the prediction 325 of Equation 12 and the numerical result 330 is related to the neglection of the weak resonator self-Kerr described by η_{C}â†â†ââ/2.

FIG. 2A shows a plot 300 of the two-qubit controlled phase ϕ_{Cph} as a function of the driving strength D for three different evolution times t. In the example shown, ϕ_{Cph} vanishes for all times for a certain D, which is marked by solid vertical line 335. This value is close to the prediction 325 of Equation 12 but differs from the prediction 320 of Equation 11. FIG. 2B shows a plot 350 of the energy shifts of different transition frequencies 355, 360, 365 as functions of the driving strength D. Dashed curves are predictions 375 of the last line of Equation 7. The devices parameters used for simulation are as follows: the detuning of the two qubits 210, 270 is Δ_{LR}/2π≈−660 MHz; the resonator drive frequency 242 is detuned from the resonator frequency 252 by Δ_{LR}/2π˜−100 MHz; the anharmonicities of the three components 210, 270, 240 are η_{L}/2π≈η_{R}/2π˜−320 MHz and η_{C}/2π≈−90 KHz; the three dispersive shifts are given by X_{L}/2π≈−6.0 MHZ, X_{R}/2π≈-8.4 MHZ, and X_{LR}′/2π=−5.7 MHz; the effective ZZ coupling 370 between the qubits 210, 270 vanishes 335 at D₀/2π≈0.27 GHz.

Besides canceling the ZZ interaction, turning on a resonator drive 242 also may shift the 0-1 excitation frequencies of the two qubits 210, 270. FIG. 2B also shows the plot 350 of the shift of the 0-1 transition frequencies. These shifts are also approximated by Equation 7. If the strength of the drive on the resonator is sufficiently stable, these frequency shifts may be calibrated experimentally.

FAST CROSS-REFERENCE GATE: A cross-resonance (CR) gate is a type of entangling gate that a) is popular to apply for a fixed-frequency architecture, and b) has longer durations than parametric gates on frequency tunable architectures. As described in detail hereinbelow, certain embodiments of a ZZ-free scheme of the present invention may advantageously reduce the required gate time, which may be comparable to those obtained for the parametric gates.

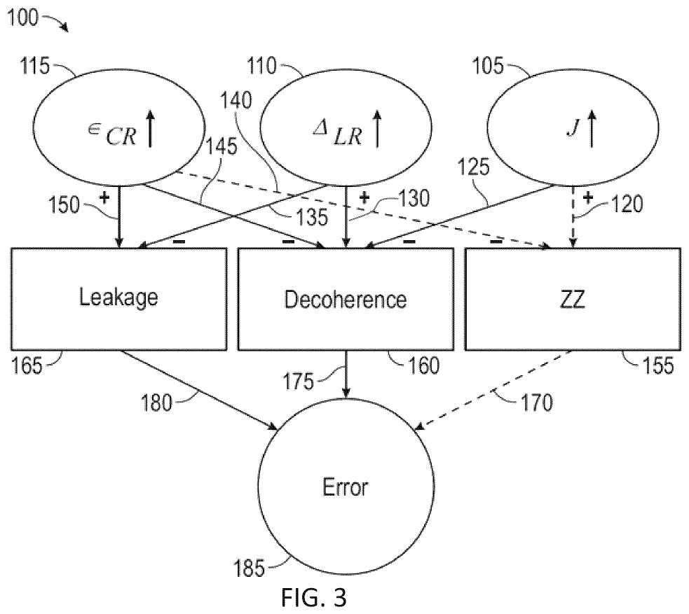

Referring now to FIG. 3, and still referring to FIG. 1, diagram 100 illustrates how traditional CR gates may be affected by the three error channels: leakage 165, decoherence loss 160, and imperfect rotations 155 due to ZZ interactions. The contributions of these channels are determined by three parameters: the two-qubit detuning ΔLR (shown as parameter 110 for error channel 160), the driving strength ∈_{CR} (shown as parameter 115 for error channel 165), and the two-qubit effective coupling strength/(shown as parameter 105 for error channel 155). The dependence is roughly characterized by positive correlations (arrows annotated with “+”) and negative correlations (arrows annotated with “−”), as shown in diagram 100. Using the architecture presented herein, the error 185 attributable to ZZ 155 may be removed (as symbolized by dashed lines for arrows 140 and 170).

To characterize the contribution of decoherence to gate errors, the strength of the coupling between the two transmon qubits 210, 270 may be modeled as J, the detuning between the respective frequencies 222, 282 of the two qubits 210, 270 may be Δ_{LR}=ω_{L}−ω_{R}, and their anharmonicities may satisfy η_{L}≈η_{R}≈η. For the resonator-mediated coupling assumed in this architecture, the coupling strength/may be approximated as shown in Equation 14, as follows:

$$J \approx {\tilde{g}}_{L} {\tilde{g}}_{R} [ \frac{{\overline{ω}}_{L} + {\overline{ω}}_{R} - 2 {\overline{ω}}_{C}}{2 ( {\overline{ω}}_{L} - {\overline{ω}}_{C} ) ( {\overline{ω}}_{R} - {\overline{ω}}_{C} )} - \frac{{\overline{ω}}_{L} + {\overline{ω}}_{R} + 2 {\overline{ω}}_{C}}{2 ( {\overline{ω}}_{L} + {\overline{ω}}_{C} ) ( {\overline{ω}}_{R} + {\overline{ω}}_{C}} ] \qquad ( 14 )$$

where, w̅_{L,R,C} are the bare frequencies of the two qubits 210, 270 and the resonator 240, and \tilde{g}_{L(R)} is the normalized coupling strength defined by \tilde{g}_{L(R)}≈E_{J}_{_{L(R)}}/32E_{C}_{_{L(R)}}]^{1/4}g_{L(R)}. To activate the CR gate, one may consider a drive 212 on the control qubit (chosen as L qubit 210) whose frequency is close to that of the target qubit (R cubit 270). The strength of this drive 212 is denoted by ECR.

Generally, a longer gate time may imply more decoherence loss. To reduce the CR gate duration, a stronger effective CR driving strength may be needed. The effective CX rotation rate induced by the CR drive is approximately ∈_{CX}≈A_{CX}∈_{CR}, where ∈_{CR} is the amplitude of the drive on the control qubit 210, and the coefficient is approximated as shown in Equation 15, as follows:

$${A}_{CX} \approx {( \frac{{E}_{{J}_{L}}}{32 {E}_{{C}_{L}}} )}^{1 / 4} \frac{2 {J}_{η}}{{Δ}_{LR} ( η + {Δ}_{LR} )} \qquad ( 15 )$$

Roughly, if the transmon loss rate is characterized by y, the decoherence error scales as shown in Equation 16, as follows:

$${Err}_{noise} \approx \frac{4 π γ}{5 \vert {ϵ}_{CX} \vert} ∝ \{ \begin{matrix}\vert {Δ}_{LR} \vert {\vert J \vert}^{- 1} {\vert {ϵ}_{CR} \vert}^{- 1} γ , & \vert {Δ}_{LR} \vert ≪ \vert η \vert , \\ {\vert {Δ}_{LR} \vert}^{2} {\vert J \vert}^{- 1} {\vert {ϵ}_{CR} \vert}^{- 1} {\vert η \vert}^{- 1} γ , & \vert {Δ}_{LR} \vert ≪ \vert η \vert\end{matrix} \qquad ( 16 )$$

The second major error source is the leakage due to off-resonant transitions. Ideally, the CR drive only may induce rotations in the target qubit 270. However, to ensure a sufficiently fast gate, the control qubit 210 may be strongly driven, as shown in Equation 15. Such drive may cause off-resonant errors. An accurate estimation of such error requires knowledge of specific parameter regimes of the device and the pulse shapes but, generally, this off-resonant error Errₗₑₐₖ may increase with larger driving strength ∈_{CR}, but may decrease with larger detuning Δ_{LR}.

The third major error source is imperfect rotation. Because of the unwanted interactions, and especially the ZZ coupling, the conditional Rabi rotation usually cannot be made fully resonant. To quantify this type of error, one may first evaluate the ZZ rate, which is approximated by Equation 17, as follows:

$${χ}_{LR}^{′} \approx \frac{4 {J}^{2} η}{( {Δ}_{LR} + η ) ( {Δ}_{LR} - η )} \qquad ( 17 )$$

$$20$$

Such coupling may introduce a coherent error roughly proportional to that shown in Equation 18, as follows:

$${Err}_{zz} ∝ {\vert \frac{{χ}_{LR}^{′}}{{ϵ}_{CX}} \vert}^{2} ∝ \{ \begin{matrix}{\vert {Δ}_{LR} \vert}^{2} {\vert J \vert}^{2} {\vert {ϵ}_{CR} \vert}^{- 2} {\vert η \vert}^{- 2} , & \vert {Δ}_{LR} \vert ≪ \vert η \vert , \\ {\vert J \vert}^{2} {\vert {ϵ}_{CR} \vert}^{- 2} , & \vert {Δ}_{LR} \vert ≪ \vert η \vert\end{matrix} \qquad ( 18 )$$

Based on the scaling laws of the magnitude of the three types of errors, no clear parameter regime may suppress all three error types simultaneously. Specifically, reducing Errₙₒᵢₛₑ requires a smaller Δ_{LR}, reducing Errₗₑₐₖ requires a smaller ∈_{CR}, and reducing Err_{ZZ} requires a smaller J. However, if all three parameters are small, then none of the three error types may be efficiently suppressed.

To overcome this apparent “trilemma,” one promising design approach is to cancel or suppress the ZZ coupling strength by introducing extra coupling elements or additional drives. Such cancellation approaches may open new parameter space for error reduction. For example, and without limitation, if one maintains a reasonable ratio ECR/ΔLR to suppress leakage, one may increase the coupling strength J between the two qubits to further reduce the gate infidelity.

In certain embodiments of a ZZ-free regime of the present invention, the third error source may advantageously be eliminated by the resonator-induced-phase (RIP) interaction, which does not introduce additional loss channels nor require fine-tuning of hardware parameters. Still referring to FIGS. 1 and 2, the drive 242 may be applied to the resonator 240, which may avoid directly heating the transmon qubits 210, 270 and affecting their coherence times. Also, the drive 242 on the coupler resonator 240 may not introduce extra overhead for redesigning single-qubit gates and measurement protocols. The highly tunable dynamical ZZ interaction may advantageously provide a tool to cancel a relatively stronger static ZZ coupling. In doing so, the ZZ-free scheme of the present invention may significantly reduce the required gate time, which may be comparable to those obtained for the parametric gates.

ZZ-FREE CR GATE: In one embodiment of the present invention, a stronger two-qubit coupling strength (effectively|J/2π|≈ 42 MHZ) is chosen. Such strong coupling may allow for exploration beyond the straddling regime, where the problem of frequency crowding between qubits may be alleviated. For example, and without limitation, choosing the detuning as Δ_{LR}/2π=−660 MHz may result in a static ZZ coupling strength of X_{LR}/2π=−5.7 MHz. To neutralize the stray coupling, the resonator may be operated at the ZZ-free point D=D₀ as shown in FIG. 2A.

To verify the viability of the CR gates, the model described in Equation 3 may be used to numerically simulate the evolution of the qubit states under CR gate drives. Choosing the L qubit 210 as the control and R qubit 270 as the target, the L qubit 210 may be driven via the charge operator \hat{n}_{L} according to Equation 19, as follows:

$${\hat{H}}_{D , L} ( t ) = 2 {ϵ}_{CR} ( t ) cos ( {ω}_{L}^{d} t ) {\hat{n}}_{L} \qquad ( 19 )$$

The bare charge operator may be transformed into a sum of contributions in the dressed basis, which may be expressed as follows (Equation 20):

$$( 20 )$$

$${\hat{n}}_{L} \to {A}_{L} {\hat{b}}_{L} + {A}_{R} {\hat{b}}_{R} + {A}_{CX} {\hat{b}}_{L}^{†} {\hat{b}}_{L} {\hat{b}}_{R} + {A}_{R}^{′} {\hat{b}}_{R}^{†} {\hat{b}}_{R} {\hat{b}}_{R} + {A}_{CX}^{′} {\hat{b}}_{L}^{†} {\hat{b}}_{L} {\hat{b}}_{R}^{†} {\hat{b}}_{R} {\hat{b}}_{R} + … H . c .$$

The coefficients in this expansion may be obtained numerically using superconducting qubit simulation. Among the terms in this expansion, the following are important for understanding and designing the CR gate. Specifically, A_{L}\hat{b}_{L} describes the drive 212 on the control qubit 210, and A_{R}\hat{b}_{R} induces single-qubit rotations on the target qubit 270. Their coefficients may be approximated as A_{L}≈(E_{J}_{_{L}}/32E_{C}_{_{L}})^{1/4} and A_{R}≈E_{J}_{_{L}}/32_{E}_{_{CL}})^{1/4}(−J/Δ_{LR}). The term A_{CX}\hat{b}†b_{L}\hat{b}_{R} may induce conditioned rotation depending on the state of the control qubit 210 as shown in the approximation of A_{CX} in Equation 20. This term may be put on resonance if the drive 212 frequency ω_{L}^{d} is chosen to be close to the frequency 282 of the target qubit ω_{R}. The other two terms shown in Equation 20 are related to the possible leakage in this gate, which the present invention advantageously aims to minimize.

Besides the drive on the resonator 240 and on the control qubit 210, a cancellation pulse may be applied to the target qubit 270 to directly correct the rotations in the target qubit 270 induced by the term A_{R}\hat{b}_{R}. This drive may be denoted by Equation 21, as follows:

$${\hat{H}}_{D , R} ( t ) = 2 {ϵ}_{cancel} ( t ) cos ( {ω}_{R}^{d} t ) {\hat{n}}_{R} \qquad ( 21 )$$

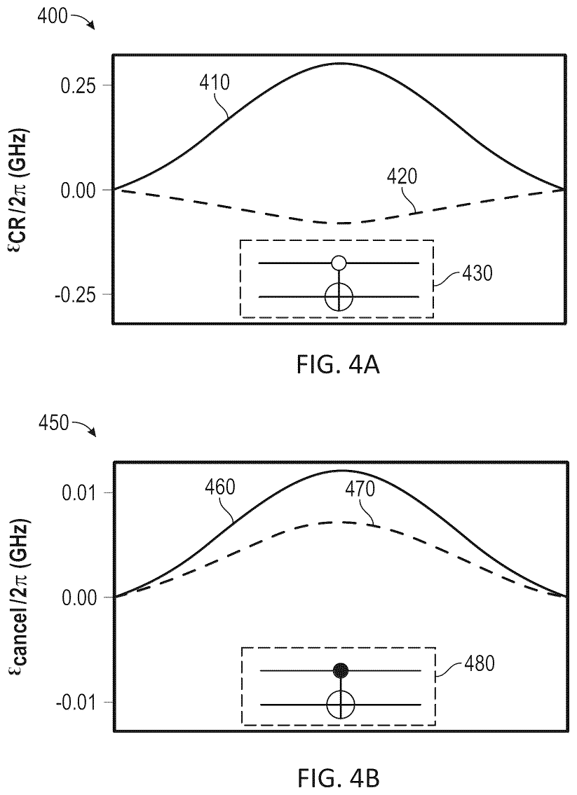

By tuning the strength and phase of ∈_{cancel}(t), this cancellation tone may activate either a 0-CNOT gate (target qubit flipped when the control is in the ground state) or a 1-CNOT gate. Referring now to FIGS. 4A and 4B, circuit diagram inset 430 of FIG. 4A represents a 0-CNOT gate and circuit diagram inset 480 of FIG. 4B represents a 1-CNOT gate. They are equivalent to each other up to single-qubit rotations. The envelopes of these two pulses ∈_{CR} (t) and E cancel (t) are shown in FIGS. 4A and 4B. Besides these two, Derivative Removal by Adiabatic Gate (DRAG) pulses may be added to mitigate leakage to the second excited state of the target qubit 270.

Both FIGS. 4A and 4B show the envelopes of the CR drive 410, 460 on the control qubit 210 and the cancellation drive 420, 470 on the target qubit 270, and their insets contain circuit diagrams for the two types of gates. The envelopes are chosen as truncated Gaussian functions (20 on each side). More specifically, FIG. 4A shows 0-CNOT gate envelopes 400 with the 0-CNOT gate envelope of CR drive 410 on the control qubit 210, the 0-CNOT gate envelope of cancellation drive 420 on the target qubit 270, and a 0-CNOT circuit diagram 430. FIG. 4B shows 1-CNOT gate envelopes with 1-CNOT gate envelope of CR drive 460 on the control qubit 210, 1-CNOT gate envelope of cancellation drive 470 on the target qubit 270, and a 1-CNOT circuit diagram 480.

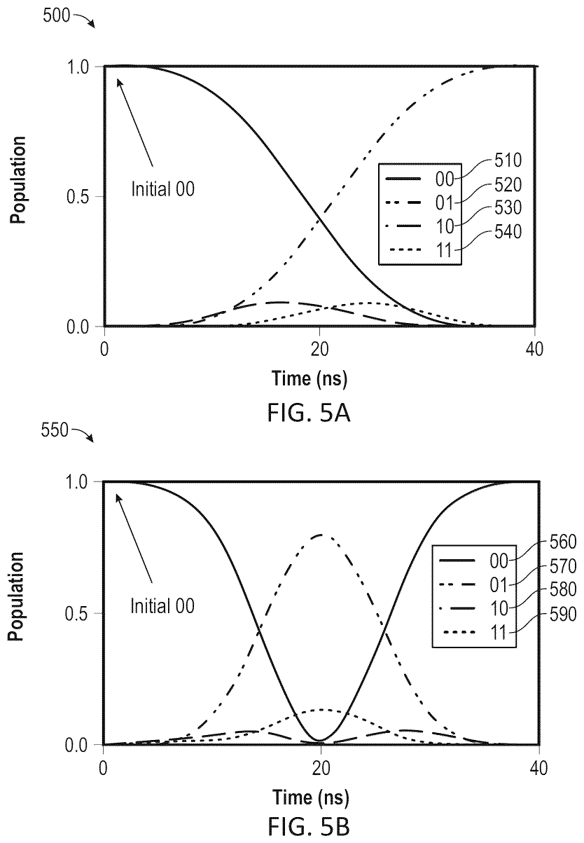

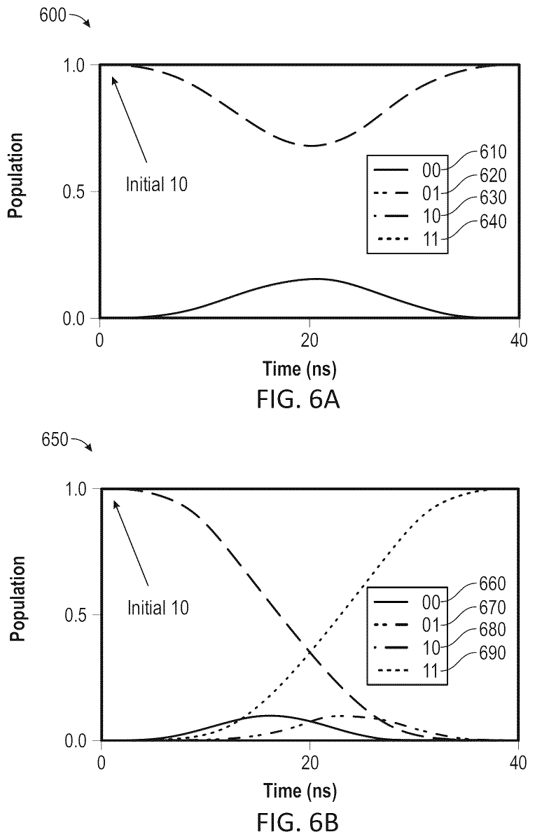

FIGS. 5A, 5B, 6A, and 6B all show evolutions of the four computational states during 40-ns gates. Referring more specifically to FIGS. 5A and 5B, graph 500 of FIG. 5A shows the 0-CNOT 40 ns gate evolution of computational states with initial state of 00. The graph 500 in FIG. 5A includes the charting of the 0-CNOT 40 ns gate evolution 510 of 00 state with initial state of 00, the 0-CNOT 40 ns gate evolution 520 of 01 state with initial state of 00, the 0-CNOT 40 ns gate evolution 530 of 10 state with initial state of 00, and the 0-CNOT 40 ns gate evolution 540 of 11 state with initial state of 00. Graph 550 of FIG. 5B shows the 1-CNOT 40 ns gate evolution of computational states with initial state of 00, which involves the 1-CNOT 40 ns gate evolution 560 of 00 state with initial state of 00, the 1-CNOT 40 ns gate evolution 570 of 01 state with initial state of 00, the 1-CNOT 40 ns gate evolution 580 of 10 state with initial state of 00, and the 1-CNOT 40 ns gate evolution 590 of 11 state with initial state of 00.

Referring now to FIGS. 6A and 6B, graph 600 of FIG. 6A shows the 0-CNOT 40 ns gate evolution of computational states with initial state of 10, which includes the 0-CNOT 40 ns gate evolution 610 of 00 state with initial state of 10, 0-CNOT 40 ns gate evolution 620 of 01 state with initial state of 10, the 0-CNOT 40 ns gate evolution 630 of 10 state with initial state of 10, and the 0-CNOT 40 ns gate evolution 640 of 11 state with initial state of 10. Graph 650 of FIG. 6B shows the 1-CNOT 40 ns gate evolution of computational states with initial state of 10, including the 1-CNOT 40 ns gate evolution 660 of 00 state with initial state of 10, the 1-CNOT 40 ns gate evolution 670 of 01 state with initial state of 10, the 1-CNOT 40 ns gate evolution 680 of 10 state with initial state of 10, and the 1-CNOT 40 ns gate evolution 690 of 11 state with initial state of 10.

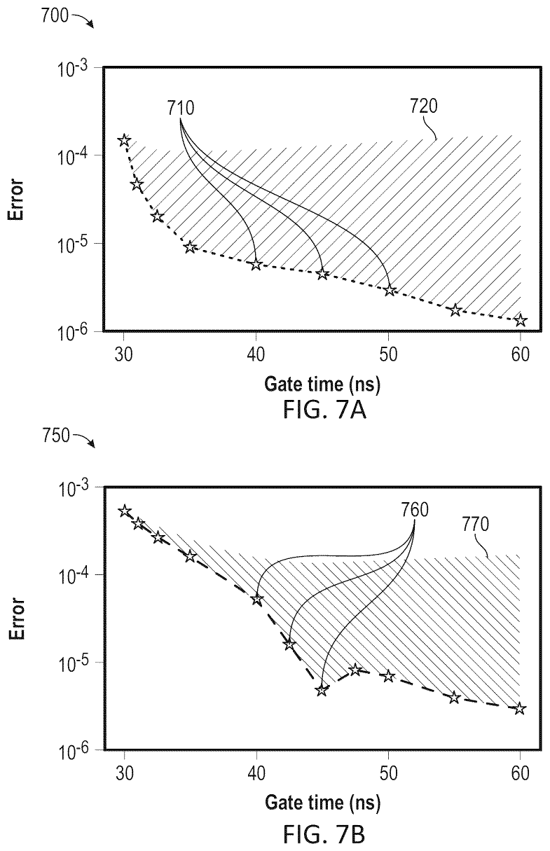

Referring now to FIGS. 7A and 7B, graph 700 of FIG. 7A displays the 0-CNOT minimized coherent gate error with 0-CNOT coherent gate errors 710 and 0-CNOT decoherence error 720. Graph 750 of FIG. 7B shows the 1-CNOT minimized coherent gate error with 1-CNOT coherent gate errors 760 and 1-CNOT decoherence error 770. Both FIGS. 7A and 7B present the minimized coherent gate error for the two types of entangling gates versus given gate times. For this optimization, ω_{R}^{d}=ω_{L}^{d} may be fixed while varying the driving frequency ω_{L}^{d}, the maximal amplitude of ∈_{CR} (t), and the maximal amplitude of ∈_{cancel}(t) to search for the minimal average gate error. As shown with stars 710, 760 in FIGS. 7A and 7B, the coherent errors are below 10⁻⁴ for most gate durations simulated. Consequently, the decoherence contribution dominates the total gate error. Even for an optimistic estimation of the transmon coherence times (T₁=T₂=500 μs), the decoherence errors still predominate the coherent ones for gate durations longer than 40 ns, which is indicated by the shaded areas 720, 770. Both the depolarization and dephasing noise may be assumed to be Markovian, allowing estimation of the decoherence rate according to known methods.

For FIGS. 4A, 4B, 5A, 5B, 6A, 6B, 7A and 7B, the strength of the drive 242 on the resonator 240 is fixed at the ZZ-free point (e.g., [symbol] = [symbol] ₀). Because the resonator drive 242 is always on in the scheme of the present invention, the computational states may be denoted J̅_̅{̅L̅}̅,̅ J̅_̅{̅R̅}̅,̅ J̅_̅{̅C̅}̅ [symbol] =Û_{dis}|j_{L}, j_{R}, j_{C} [symbol] (j_{L}>j_{R}=0,1; j_{C}=0) rather than the eigenstates of the undriven system, |j_{L}j_{R}, j_{C} [symbol] . Here, j_{L,R,C} denote the numbers of excitations in the three components.

By fine-tuning the pulse parameters, the two types of entangling gates may be numerically realized with gate times ranging from 30 to 60 ns. For a clearer demonstration of this gate, the evolution of the populations of the four computational states during a 40-ns gate may be plotted as shown in FIGS. 5A and 6A for the 0-CNOT gate and as shown in FIGS. 5B and 6B for the 1-CNOT gate. Per these illustrations, the target qubit 270 may end up in different states for different initial states of the control qubit 210. FIGS. 7A and 7B show the optimized gate fidelities for different gate times. The coherent error is negligible (approximately 10⁻⁵) for gate times as short as 40 ns.

For such low coherent errors, the two-qubit gates still may be limited by the transmon decoherence. For the state-of-the-art coherence times of the transmon qubits (T₁=T₂₌₅₀₀ μs), the gate error of this gate is below 10⁻⁴ for a 40-ns duration, as shown in FIGS. 7A and 7B. Even for more moderate coherence times such as T₁=T₂=100 μs, this error may still reach as low as 5×10⁻⁴. Such error may be further reduced once the coherence times of single transmon qubits are further improved, and the absence of flux-tunable elements spares the gates from suffering from other prominent decoherence channels.

ADIABATIC CZ GATES: Besides the CR gates, certain embodiments of an architecture of the present invention may support other entangling operations, which may complement the gates introduced previously. For example, and without limitation, one can engineer CZ gates via the RIP interaction by adiabatically tuning the resonator driving strength. This strategy is analogous to that used in gates enabled by tunable couplers.

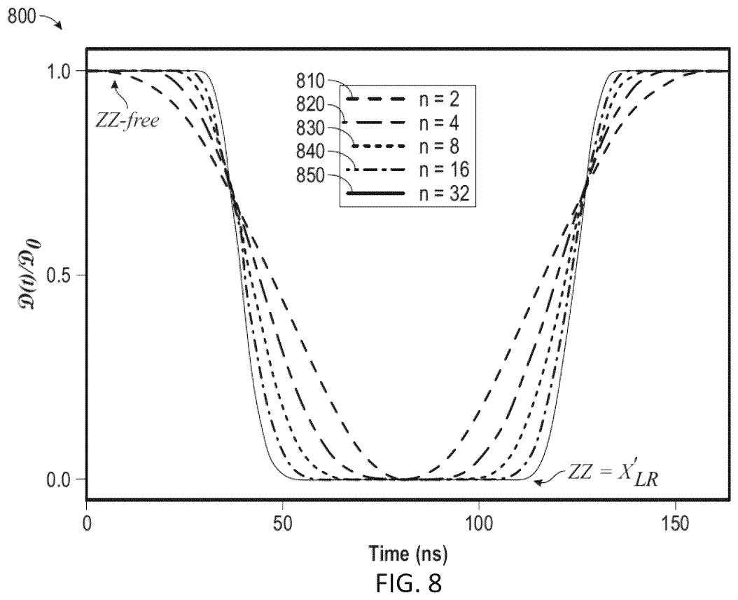

Specifically, [symbol] in Equation 4 may be adiabatically moved away from the cancellation point [symbol] ₀ over a certain duration T_{g} and returned back. The ZZ coupling may be recovered during this process, which may be used to engineer CZ gates. To maximally accelerate the entangling gate, [symbol] may be adiabatically tuned to 0, for example, as shown in graph 800 of FIG. 8. This graph 800 illustrates the envelopes of resonator drives for adiabatic CZ gates. The different curves correspond to different parameters n in Equation 22. Included are the n=2 envelope 810, the n=4 envelope 820, the n=8 envelope 830, the n=16 envelope 840, and the n=32 envelope 850. To ensure high-fidelity state transfers, an analytically designed pulse envelope may be chosen, for example, as shown in Equation 22, as follows:

$$D ( t ) = {2}^{n} {{D}_{0} [ 10 {( \frac{t}{{T}_{g}} )}^{3} - 15 {( \frac{t}{{T}_{g}} )}^{4} + 6 {( \frac{t}{{T}_{g}} )}^{5} - \frac{1}{2} ]}^{n} \qquad ( 22 )$$

where the first- and second-order derivatives vanish at t=0 and t=t for n=2m, m E [symbol] ⁺. Such a feature may be advantageous for preserving adiabaticity in the state evolution of a harmonic oscillator.

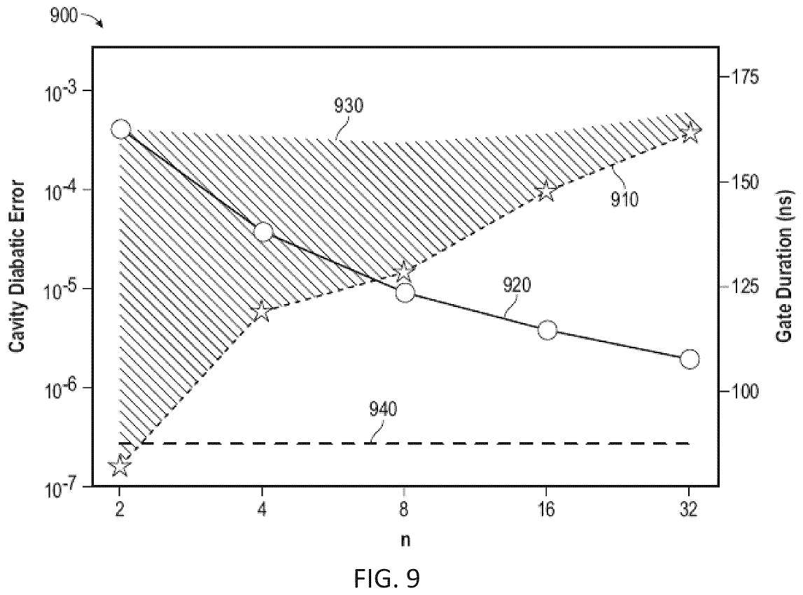

Referring now to FIG. 9, graph 900 shows optimized gate durations for adiabatic CZ gates as a function of n. Included are the resonator diabatic error 910, the optimized gate duration 920, the decoherence contribution of transmon qubits 930, and the lower bound of the gate duration 940. The lower bound of the gate duration 940 is set by Tₘᵢₙ=R/X_{LR}′. The decoherence contribution for transmon qubits 930 is T₁=T₂=500 μs.

By increasing n, the ramp time of the pulse may be shortened, as shown in FIG. 8, which may lead to faster CZ gates at the cost of more diabatic leakage. To verify this, n may be increased from 2 to 32 to find optimal gate durations for the target CZ gates. As shown in FIG. 9, the gate duration decreases from 160 to 110 ns, while the error due to diabatic resonator evolution increases from a negligible value to 4×10⁻⁴, approaching the decoherence limit. In addition, shorter pulse duration eventually results in a broader bandwidth of the pulse, which increases the risk of photon exchanges between the qubits and the resonator and leads to more errors. In principle, this problem may be alleviated by carefully choosing the hardware and driving parameters.

Although the durations of such CZ gates are relatively longer than those of the CR gates studied previously, they require simpler control protocols which are especially convenient for experiments where strong transmon drives are unavailable.

RESONATOR DECOHERENCE: Hereinabove, the decoherence time of the resonator is assumed to be exceedingly longer than the decoherence times of the qubits, and thus has a negligible impact on error. However, there may be conditions where the decoherence time of the resonator is not exceedingly longer than those of the qubits. In these instances, the following Equation 23 may be used to quantify the error caused by the decoherence of the resonator:

$${Γ}_{m , L} \approx \frac{2 \overline{n} {K}_{C} {χ}_{L}^{2}}{{K}_{c}^{2} + {χ}_{L}^{2} + 4 {Δ}_{d}^{2}} \qquad ( 23 )$$

wherein K_{C} denotes the resonator loss rate and n̅ denotes the average photon number kept in the resonator. The detuning d may be much larger than X_{L} and K_{C}. Under the limit Δ_{d}>>X_{L}, K_{C}, Equation 23 may be further approximated as Γ_{m,L}≈(n̅X_{L}²/2Δ_{d}²) K_{C}. For a simple estimation, the following parameters are Δ_{d}/2π=100 MHZ, X_{L}/2π=6 MHZ, and n̅≈10. Therefore, for the resonator lifetime 1/K_{C}=100 μs, the coherence limit on the transmon qubit is approximately 5 ms, which is still much higher than its typical dephasing time.

FOUR-WAVE MIXING: In traditional CR gates, the charge drives on either qubit usually only affect the qubits because the frequencies of these drives are far detuned from that of the resonator excitation. However, when a displacement drive is applied to a resonator 240, as described hereinabove, a four-wave-mixing interaction between the qubit and the resonator 240 may occur. This interaction is evident when inspecting the transformation of \hat{b}_{L(R)} according to the unitary Û_{dis}. Toward this expansion, Û_{dis} is expressed as a Taylor series in Equation 24, as follows:

$${\hat{U}}_{dis} = exp [ \frac{D ( {\hat{a}}^{†} - \hat{a} )}{{Δ}_{d}} {\sum }_{k = 0}^{∞} {( \frac{χ {\hat{b}}_{L}^{†} {\hat{b}}_{L + {χ}_{R} {\hat{b}}_{R}^{†} {\hat{b}}_{R}}}{{Δ}_{d}} )}^{k} ] \qquad ( 24 )$$

To the leading order of X_{L},R/Δ_{d}, Equation 25 is derived as follows:

$${\hat{b}}_{L ( R )} \to {\hat{U}}_{dis}^{†} {\hat{b}}_{L ( R )} {\hat{U}}_{dis} \approx {\hat{b}}_{L ( R )} + \frac{{D}_{{χ}_{L ( R )}}}{{Δ}_{d}^{2}} ( {\hat{a}}^{†} - \hat{a} ) {\hat{b}}_{L ( R )} \qquad ( 25 )$$

This four-wave mixing advantageously may not introduce additional gate errors when using the hardware and drive parameters chosen hereinabove for ZZ cancellation and the CR gates.

DRIVE AMPLITUDE INSTABILITY: In certain implementations of an architecture of the present invention, the resonator drive amplitude may fluctuate which may lead to a fluctuation of the transmon energies and further contribute to the dephasing of qubits. The phase uncertainty at time t for a certain transition energy \tilde{w}(D) as a function of D may be estimated using the relation of Equation 26, as follows:

$$〈 exp [ - it \frac{\partial \tilde{ω}}{\partial D} \partial D ] 〉 = exp [ - \frac{{σ}_{D}^{2}}{2} {( \frac{\partial ω}{\partial D} )}^{2} {t}^{2} ] \qquad ( 26 )$$

From Equation 26, the dephasing rate of Equation 27, as follows, may be obtained:

$${Γ}_{D} = \frac{{σ}_{D}}{\sqrt{2}} \vert \frac{\partial \tilde{ω}}{\partial D} \vert \qquad ( 27 )$$

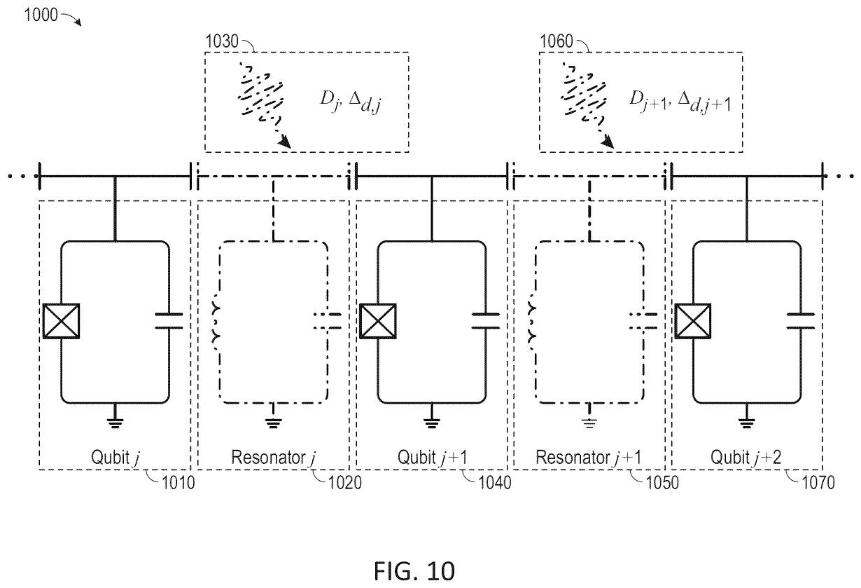

QUBIT NETWORK ZZ-FREE ARCHITECTURE: Referring now to FIG. 10, a quantum computing system according to certain embodiments of the present invention may comprise a qubit-resonator chain 1000 including more than two qubit devices and more than one resonator device. For example, and without limitation, the qubit-resonator chain 1000 may consist of N qubit devices and N-1 resonator devices. The qubit-resonator chain may include a j^{th} qubit device 1010 characterized by a control frequency ω_{q,j}, a j+l^{th} qubit device 1040 characterized by a control frequency ω_{q,j+1}, and a j+2^{nd} qubit device 1070 characterized by a control frequency ω_{q,j+2}. The qubit-resonator chain 1000 may further include a j^{th} resonator device 1020 characterized by a resonator frequency ω_{c,j} having a detuning gapⱼ from the control frequency ω_{q,j} and from the control frequency ω_{q,j+1}; and a j+l^{th} resonator device 1050 characterized by a resonator frequency ω_{c,j+1} having a detuning gapⱼ₊ₗ from the control frequency ω_{q,j+1} and from the control frequency ω_{q,j+2}. The j^{th} resonator drive 1020 may also have a microwave drive configured to apply a j^{th} resonator drive frequency ω_{c,j}^{d} at a drive strength [symbol] ⱼ 1030 substantially equal to a ZZ-free operating point [symbol] _{0,j} of a controlled phase for the j^{th} qubit 1010, j^{th} resonator 1020, j+l^{th} qubit 1040, j+l^{th} resonator 1050, and j+2^{nd} qubit devices 1070. The j+l^{th} resonator drive 1050 may also have a microwave drive configured to apply a j+l^{th} resonator drive frequency ω_{c,j+1}^{d} at a drive strength [symbol] ⱼ₊ₗ 1060 substantially equal to a ZZ-free operating point [symbol] _{0,j+1} of a controlled phase for the j^{th} qubit 1010, j^{th} resonator 1020, j+l^{th} qubit 1040, j+l^{th} resonator 1050, and j+2^{nd} qubit devices 1070.

The N-1 resonator devices may be two-dimensional (2D) high-coherence resonator types or three-dimensional (3D) high-coherence resonator types. Further, the N-1 resonator devices may comprise a superconducting radio frequency cavity (SRF). The N qubit devices may be of the fixed-frequency transmon type.

The j^{th} 1010, j+l^{th} 1040, and j+2^{nd} 1070 qubit devices may be of the two-qubit electrode type. The j^{th} 1010 and j+l^{th} 1040 qubits may be capacitively coupled to the j^{th} resonator 1020, while the j+l^{th} 1040 and j+2^{nd} 1070 qubits may be capacitively coupled to the j+l^{th} resonator 1050. The j^{th} 1020 and j+l^{th} 1050 resonators may also be in a displaced vacuum state during the controlled phase.

When the j^{th} 1010 and j+l^{th} 1040 qubits are coupled to the j^{th} resonator 1020, the chain may be represented by Equation 28 hereinbelow. In Equation 28, â; is the annihilation operator for the j^{th} resonator, and ωC,j denotes its frequency; \hat{b}ⱼ is the annihilation operator for the qubits and ω_{q,j} denotes their frequency, as follows:

$${\hat{H}}_{chain} = {\sum }_{j = 1}^{N} ( {ω}_{q , j} {\hat{b}}_{j}^{†} {\hat{b}}_{j} + \frac{{η}_{q , j}}{2} {\hat{b}}_{j}^{†} {\hat{b}}_{j}^{†} {\hat{b}}_{j} {\hat{b}}_{j} ) + {\sum }_{j = 1}^{N - 1} {ω}_{C , j} {\hat{a}}_{j}^{†} {\hat{a}}_{j} + {\sum }_{j = 1}^{N - 1} {χ}_{j , j + 1}^{′} {\hat{b}}_{j + 1}^{†} {\hat{b}}_{j + 1} {\hat{b}}_{j}^{†} {\hat{b}}_{j} + {\sum }_{j = 1}^{N - 1} ( {χ}_{j , j + 1} {\hat{b}}_{j + 1}^{†} {\hat{b}}_{j + 1} + {χ}_{j , j} {\hat{b}}_{j}^{†} {\hat{b}}_{j} ) {\hat{a}}_{j}^{†} {\hat{a}}_{j} \qquad ( 28 )$$

To cancel stray ZZ interactions between adjacent qubits, the driving strength [symbol] ⱼ may be set as the solution of Equation 29. To avoid crosstalks in the resonator drives, the detuning d,j may be chosen accordingly, as follows:

$$( 29 )$$

$${D}_{j}^{2} ( \frac{1}{{Δ}_{d , j} - {χ}_{j , j} - {χ}_{j , j + 1}} + \frac{1}{{Δ}_{d , j}} - \frac{1}{{Δ}_{d , j} - {χ}_{j , j}} - \frac{1}{{Δ}_{d , j} - {χ}_{j , j + 1}} ) + {χ}_{j , j + 1}^{′} = 0$$

A qubit-resonator chain, as depicted in FIG. 10, may also contain additional resonators connected to the j^{th} 1010 and j+2^{nd} 1070 qubits on either end of the chain 1000. These additional resonators may help mitigate the ZZ couplings of non-adjacent qubits.

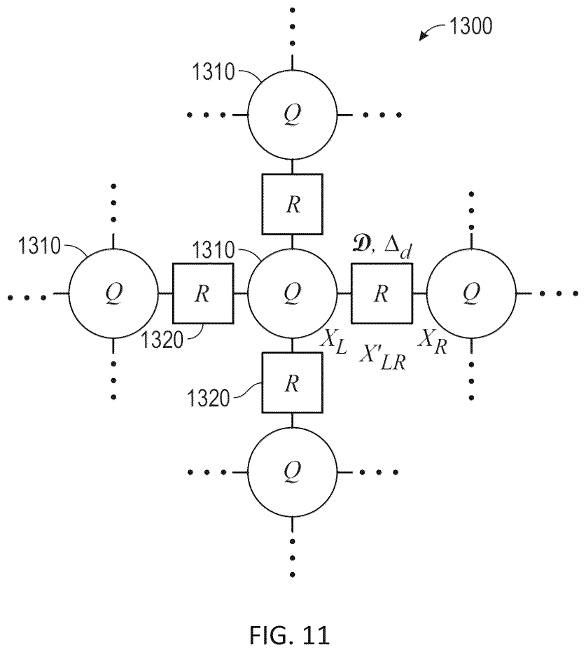

Referring now to FIG. 11, a quantum computing system according to certain embodiments of the present invention may comprise a 2D lattice network 1300 of qubit devices 1310 and resonator devices 1320. The ZZ interactions in a 2D lattice network 1300 may be canceled by choosing drive parameters that satisfy Equation 12 for each adjacent transmon pair. Similar to three qubit chains, a 2D qubit-resonator lattice network may also experience ZZ coupling between non-adjacent qubits, or ZZZ coupling. These additional ZZ and ZZZ couplings may be addressed by adding additional coupling resonators to the unused diagonals of the square lattice, thereby providing the additional degrees of freedom to further cancel ZZ coupling.

While the above and attached descriptions contain much specificity, these should not be construed as limitations on the scope of any embodiment, but as exemplifications of the presented embodiments thereof. Many other modifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are, unless otherwise stated, used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus, the scope of the invention should be determined by the following claims and their legal equivalents, and not limited by the examples given. While the invention has been described and illustrated with reference to certain fabricated embodiments thereof, those skilled in the art will appreciate that various changes, modifications and substitutions can be made therein without departing from the spirit and scope of the invention. It is intended, therefore, that the invention be limited only by the scope of the claims which follow, and that such claims be interpreted as broadly as possible.

What is claimed is:

1. A quantum computing system comprising:
a superconducting quantum processor unit (QPU) comprising:
a control qubit device characterized by a control frequency ω_{L},
a target qubit device characterized by a target frequency ω_{R}, and
a resonator device coupled between the control and target qubit devices, and characterized by a resonator frequency ω_{C} having a detuning gap from the control frequency ω_{L} and from the target frequency ω_{R}; and
a microwave drive configured to apply to the resonator device a resonator drive frequency ω_{c}^{d} at a drive strength D substantially equal to a ZZ-free operating point D₀ of a controlled phase for the control qubit, resonator, and target qubit devices.

2. The quantum computing system according to claim 1, wherein the resonator device is of one of a two-dimensional (2D) high-coherence resonator type and a three-dimensional (3D) high-coherence resonator type.

3. The quantum computing system according to claim 1, wherein each of the control and target qubit devices is of a two-qubit electrode type and capacitively connected to the resonator device.

4. The quantum computing system according to claim 1, wherein each of the control and target qubit devices is of a fixed-frequency transmon type.

5. The quantum computing system according to claim 1, wherein the resonator device comprises a superconducting radio frequency (SRF) cavity.

6. The quantum computing system according to claim 1, wherein the detuning gap is approximately 5 gigahertz (GHz).

7. The quantum computing system according to claim 6, wherein the control frequency ω_{L} is detuned from the target frequency ω_{R} at less than the detuning gap of the resonator frequency ω_{C}.

8. The quantum computing system according to claim 1, wherein the resonator device is in a displaced vacuum state during the controlled phase.

9. The quantum computing system according to claim 1, wherein the superconducting quantum processor unit (QPU) is of a two-qubit entangling gate type selected from the group consisting of a cross-resonance (CR) Controlled-NOT (CNOT) gate type and an adiabatic Controlled-Z (CZ) gate type.

10. A quantum computing system comprising:
a qubit-resonator chain comprising:
a plurality N of qubit devices, including a j^{th} qubit device characterized by a control frequency ω_{q,j} and a j+l^{th} qubit device characterized by a control frequency ω_{q,j+1};
a plurality N-1 of resonator devices coupled between adjacent pairs of the plurality N of qubit devices, including a j^{th} resonator device characterized by a resonator frequency ω_{c,j} having a detuning gap; from the control frequency ω_{q,j} and from the control frequency ω_{q,j+1}; and
a microwave drive configured to apply to the j^{th} resonator device a j^{th} resonator drive frequency ω_{c,j}^{d} at a drive strength Dⱼ substantially equal to a ZZ-free operating point D_{0,j} of a controlled phase for the j^{th} qubit, j^{th} resonator, and j+l^{th} qubit devices.

11. The quantum computing system according to claim 10, wherein at least one of the plurality N-1 of resonator devices is of one of a two-dimensional (2D) high-coherence resonator type and a three-dimensional (3D) high-coherence resonator type.

12. The quantum computing system according to claim 10, wherein each of the jth and j+lth qubit devices is of a two-qubit electrode type and capacitively connected to the jth resonator device.

13. The quantum computing system according to claim 10, wherein each of the plurality N of qubit devices is of a fixed-frequency transmon type.

14. The quantum computing system according to claim 10, wherein at least one of the plurality N-1 of resonator devices comprises a superconducting radio frequency (SRF) cavity.

15. The quantum computing system according to claim 10, wherein the detuning gapⱼ is approximately 5 gigahertz (GHz).

16. The quantum computing system according to claim 10, wherein the jth resonator device is in a displaced vacuum state during the controlled phase.

17. The quantum computing system according to claim 10, further comprising an Nth resonator device coupled between a non-adjacent pair of the plurality N of qubit devices.

18. A method of operating a superconducting quantum processor unit (QPU) comprising a control qubit device characterized by a control frequency ω_{L}, a target qubit device characterized by a target frequency ω_{R}, and a resonator device coupled between the control and target qubit devices and characterized by a resonator frequency ω_{C} having a detuning gap from the control frequency ω_{L} and from the target frequency ω_{R}; the method comprising the step of:
applying, using a microwave drive, a resonator drive frequency ω_{C} to the resonator device at a drive strength D substantially equal to a ZZ-free operating point d₀ of a controlled phase for the control qubit, resonator, and target qubit devices.

19. The method according to claim 18, further comprising applying a control drive frequency ω_{L}^{d} to the control qubit device.

20. The method according to claim 18, further comprising applying a target drive frequency ω_{R}^{d} to the target qubit device.
